(19) United States
(12) Patent Application Publication
(10) Pub. No.: US 2006/0051634 A1
(43) Pub. Date: Mar. 9, 2006

(54) Power controller for fuel cell

(75) Inventor: Peter David DeVries, Spokane, WA (US)

Correspondence Address: ANDRUS, SCEALES, STARKE & SAWALL, LLP, 100 EAST WISCONSIN AVENUE, SUITE 1100, MILWAUKEE, WI, 53202, US

(73) Assignee: Genesis Fueltech, Inc., Spokane, WA (US)

(21) Appl. No.: 10/937,186

(22) Filed: Sep. 9, 2004

(51) Int. Cl. H01M 8/04; H01M 8/06

(52) U.S. Cl. 429/23; 429/19

(57) ABSTRACT

A fuel cell power system includes a fuel cell stack having at least two fuel cell groups in series with each other and with each fuel cell group having more than one individual fuel cell, and a power controller which receives electrical power from the fuel cell stack and distributes the electrical power to an output bus. The power controller includes a DC-DC converter, and a reduction logic circuit operative to limit current through the DC-DC converter in response to voltage across each fuel cell group so that a minimum voltage is maintained across each fuel cell group. When used in combination with a hydrogen reformer, the reduction logic circuit is also operative to limit current through the DC-DC converter in response to hydrogen pressure supplied by the reformer to the fuel cell stack so that a minimum pressure is maintained for the hydrogen supplied to the fuel cell stack.

### FIELD OF THE INVENTION

This invention relates to electrochemical power systems which utilize a power controller for regulating the power output of electrochemical fuel cells. Specifically, a power controller is disclosed which has means to protect a fuel cell from undervoltage conditions which may cause damage to the cells. In the preferred embodiment, this controller includes a DC-DC converter which also provides a regulated power output suitable for charging batteries or powering loads.

### BACKGROUND OF THE INVENTION

Fuel cell power systems are becoming an increasingly viable source of electrical power for a wide variety of applications. Potential uses vary from miniature power systems for hand-held scanners to electromotive power for oceangoing vessels.

One of the drawbacks with fuel cells is the wide swing in the output voltage, which occurs as the load varies. This makes coupling the direct output of the fuel cell to electrical loads difficult. To mitigate this problem, it is often much more practical to add a DC-DC converter downstream of the fuel cell. This DC-DC converter may be used to regulate the charging of batteries, or hold a constant output bus voltage.

In the course of operating a fuel cell, there will typically be some variance in performance between the cells of a multi-cell system. In severe instances, a single cell can become negatively biased at higher current levels, so that all of the current and voltage in the cell produces heat. This can, in turn, destroy the individual cell.

To prevent reverse biasing of cells, various means have been employed. Fuglevand, et. al., in U.S. Pat. No. 6,096,449 disclose a method of using diodes and transistors, which prevent a failing cell from reverse biasing to a large degree. Others, such as Lacy in U.S. Pat. No. 6,313,750 employ voltage sensing means across each cell, to detect an event where a cell becomes negatively biased. When this occurs, the load on the fuel cell may either be reduced, or disconnected, to prevent damage from taking place at the reverse biased cell.

Sensing each cell voltage in a multi-cell fuel cell system adds cost and complexity. Individual voltage taps must be connected to the stack, connected to a wiring harness, and transmitted to a circuit for analog-to-digital conversion. Since each cell is at a different potential, this circuit can become quite complex, adding cost to the fuel cell system.

### SUMMARY OF THE INVENTION

The present invention provides simplified means of protecting the cells in a fuel cell from damage, utilizing a novel circuit combined with a DC-DC converter.

In a properly operating fuel cell system, variances in the cell-to-cell voltages will be small. These differences, however, are most pronounced at maximum current levels where the cell voltages are at their minimum points. Furthermore, it is important to maintain a minimum cell voltage, particularly at higher amperage conditions. This is because the waste heat generated within the cell increases as the cell voltage drops. For example, in a hydrogen/air fuel cell system, the waste heat per cell will equal:
Waste heat=(1.254−Cell Voltage) *Cell Current (1)
where the open circuit potential is 1.254 volts. As the cell voltage drops below zero volts, all of the wattage in the cell will typically be dissipated as heat. To prevent excess heat from being generated in a cell, each cell is ideally kept above approximately 0.5 volts in hydrogen/air fuel cell systems. For this reason, each cell is usually monitored. This can prevent physical damage of the cell caused by excessive temperature when a cell becomes negatively biased.

Another method of preventing cell overheating is to limit the current during a reverse-biased cell event. For example, from equation (1), if a cell is operating at 0.627 volts and 10 amperes, the waste heat will equal 6.27 watts. This waste heat in a typical fuel cell system will be dissipated by a cooling means, which maintains the fuel cell at a desired temperature. In the case where the cell becomes negatively biased at −0.627 volts, the current must be decreased by lowering the amperage to 3.33 amperes in order to keep the cell at the same temperature. This lower amperage will mean that the remaining cells will have a voltage higher than 0.627 volts/cell, assuming they are operating properly. Therefore, there can be a group of cells, where if a minimum voltage is maintained for that group of cells, a reverse-biased cell may actually cool down instead of overheat. If we assume that the cells produce 3.33 amperes at 0.766 volts/cell, for example, a group of 10 cells held at a minimum of 6.27 volts will compensate for a single reverse-biased cell of −0.627 volts by lowering the current, such that the power dissipation for the reverse-biased cell will be the same as when the cell was operating normally at +0.627 volts. Selection of the minimum number of cells and the minimum composite voltage can thus guarantee thermal stability of the cells, preventing the so-called “thermal runaway” situation seen in certain fuel cell types.

Reducing the physical interval of data-taking to several groups of cells in a fuel cell stack decreases cost. However, it is possible to decrease cost further by eliminating the need to carefully monitor the fuel cell voltage itself with a microprocessor. For example, in a DC-DC converter power system coupled to a fuel cell stack, it not important for the converter to-know the exact voltages of the cells, or even groups of cells. All that is needed is for the voltage of each group of cells to exceed a set minimum voltage. A comparator and a reference voltage provide a means for accomplishing this for each group of cells, and the Boolean combination of these comparisons provide a means for limiting the power draw from the fuel cell with the DC-DC converter when necessary, thus protecting the fuel cells from overheating.

In the case where a microprocessor is used to monitor groups of cells, the microprocessor may be used to directly control the DC-DC converter.

Reduction of the fuel cell current to maintain a desired voltage of a fuel cell group can protect individual cells from overheating. An additional protective measure is also useful when the hydrogen is supplied from a reformer or other hydrogen producing device. In this case, variations in load may cause temporary shortfalls in the supply of hydrogen, causing the hydrogen supply pressure to the fuel cell to drop too low for effective operation of the fuel cell. When this occurs the current in the fuel cell may be reduced through the control of the DC-DC converter such that the hydrogen supply pressure to the fuel cell is always maintained above a certain pressure. In such cases it is typically advantageous to have a battery to supply power to the load when the fuel cell output is temporarily limited to maintain a minimum hydrogen feed pressure.

### BRIEF DESCRIPTION OF THE DRAWINGS

FIG. 1 is a schematic illustration of a fuel cell power system incorporating a power controller in accordance with the present invention;

FIG. 2a illustrates a first embodiment of the power controller;

FIG. 2b illustrates a second embodiment of the power controller;

FIG. 3 illustrates a first embodiment of a reduction logic circuit used in the power controller to prevent overheating of one or more individual fuel cells;

FIG. 4 illustrates a second embodiment of the reduction logic circuit; and

FIG. 5 illustrates a third embodiment of the power controller which utilizes a microprocessor.

### DETAILED DESCRIPTION OF THE INVENTION

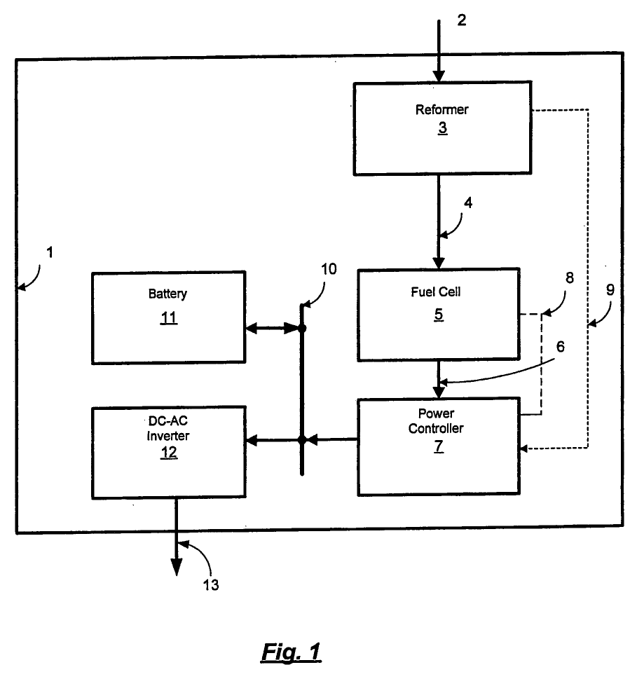

FIG. 1 schematically illustrates a typical embodiment of a fuel cell power system with a power controller. Enclosure 1 contains reformer 3, which draws fuel through fuel inlet 2. Hydrogen produced by reformer 3 travels to fuel cell 5 via hydrogen line 4. Electrical power produced by fuel cell 5 is sent via line 6 to power controller 7, where it is then routed to DC bus 10. DC bus 10 can charge batteries 11 or send power to DC-AC inverter 12. Power controller 7 is configured to reduce the power output of fuel cell 5 responsive to one or both of the signals in lines 8 and 9. Line 8 provides a signal representative of the voltage across a stack or plurality of fuel cells while line 9 provides a signal representative of hydrogen pressure to fuel cell 5 in line 4. Reformer 3, fuel cell 5, battery 11 and DC-AC inverter 12 may be of any conventional type, and their structure and operation are well known to those skilled in this art.

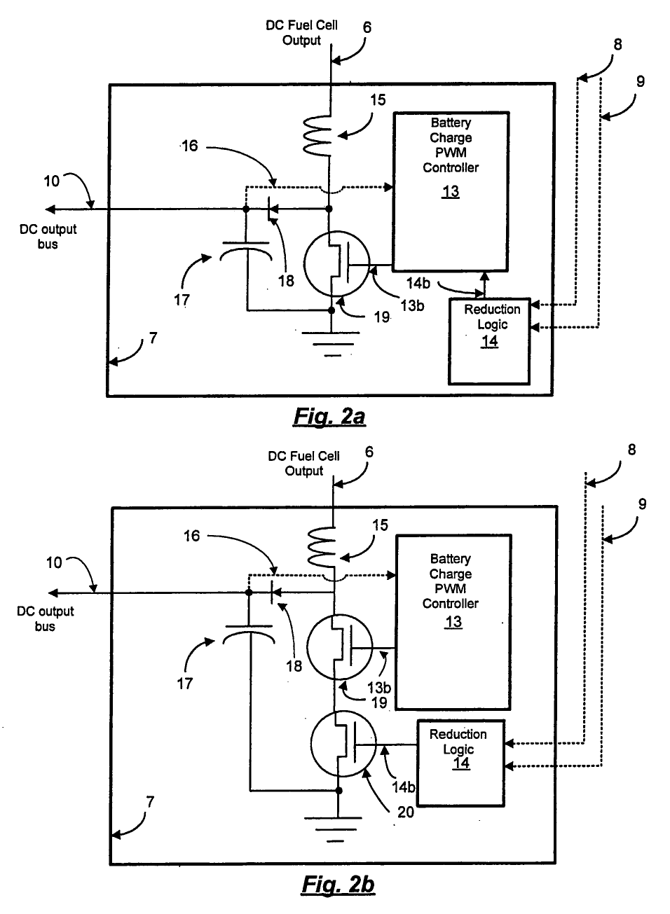

FIGS. 2a and 2b depict a representative power controller in the form of a DC-DC boost converter. Other power control means may also be employed, such as buck converters, periodic switching, and so forth. The various types being commonly known to those skilled in the art. Referring to FIG. 2a, power output from the fuel cells is fed via line 6 into power controller 7 and then to DC bus 10. The power controller 7 comprises a DC-DC converter, a battery charge pulse width modulation (PWM) controller 13, and a reduction logic circuit 14. The output bus 10 receives power from the DC-DC converter within controller 7, while the operation of the DC-DC converter is controlled via battery charge PWM controller 13. Additional inputs to battery charge PWM controller 13, such as battery temperature measurement, battery charging current, and the like, are not illustrated for brevity. Battery charge PWM controllers are readily available as an integrated circuit chip, such as the Unitrode UC3909 (Unitrode Corporation, Merrimack N.H.). Likewise, a variety of control means may be employed for the DC-DC converter transistor 19, not limited to battery charging PWM controllers, in applications where battery charging duties may not be necessary.

Under normal circumstances, battery charge PWM controller 13 will send a pulse-width modulated control signal via line 13b to the gate of transistor 19, causing the low voltage side of inductor 15 to be tied to ground. Transistor 19 is typically a MOSFET or similar device with a low on-state resistance. An example of such a MOSFET is an 80 ampere-rated n-channel device with a 3.8 mΩ channel resistance, part number FDP038AN06A0 (Fairchild Semiconductor Corporation). Inductors are commonly available and are sized for the specific application; for a 30 kHz, 500 watt DC-DC converter transmitting about 20 amperes, a 350 pH inductor, part number C-36-00029-01 (Coilsws.com, Inc., Santa Ana, Calif.) is appropriate. Thus, when activated, transistor 19 acts as an open switch to prevent power from being transmitted to output bus 10 and allows inductor 15 to charge. Upon deactivation of transistor 19 during the “off” portion of the pulse width modulated control signal, transistor 19 acts as an open switch so that inductor 15 will discharge through diode 18 into capacitor 17 and DC output bus 10. Capacitor 17 will absorb some of the power directed to output bus 10 to smooth out any power spikes to provide relatively consistent power to bus 10. Standard electrolytic capacitors are adequate for capacitor 17; for the 30 kHz, 500 watt example a 1,000 μF capacitor will work well. The diode 18 may be of a standard type, but is more preferably of a type with a low forward voltage, such as Schottky rectifier, part number 30CTQ040 (International Rectifier, El Segundo, Calif.). Upon reactivation of transistor 19, inductor 15 re-charges. The above sequence continuously occurs under normal circumstances to provide a relatively steady supply of DC power via output bus 10. The voltage to output bus 10 is sensed and provides a feedback signal via line 16 to battery charge PWM controller 13 which in turn is used to control or modulate the signal being provided to the gate of transistor 19 so that the desired voltage is maintained to output bus 10.

If conditions warrant, the appropriate signals will be transmitted through signal lines 8 and/or 9 to reduction logic circuit 14, which will then send a reduction signal 14b to battery charge PWM controller 13. Reduction signal 14b is operative to alter the control signal sent to transistor 19, such that less power is demanded of fuel cell 5. A signal from line 8 would indicate voltage across a stack of individual fuel cells has dropped below a desired minimum voltage. Preferably, the average cell voltage within each fuel cell group is at least 0.35 volts, and more preferably at least 0.5 volts. A signal from line 9 would indicate the hydrogen pressure in line 4 is below a desired minimum pressure. Preferably, a minimum pressure of at least 0.1 psig, and more preferably at least 1.0 psig, should be maintained in line 4. Thus, the width of the pulse of the control signal from battery charge PWM controller 13 to the gate of transistor 19 is modulated or modified to reduce the power to output bus 10 by increasing the length of the “on” portion of the pulse. As a result, the transistor 19 is turned off or activated for a relatively shorter period of time which in turn lowers the power sent to bus 10.

FIG. 2b illustrates a second embodiment for the power controller 7 which utilizes a second transistor 20 in series with transistor 19. In FIG. 2b, the reduction logic circuit 14 will send a reduction signal 14b to the gate of transistor 20, such that it will act as an open switch, stopping the flow of power through power controller 7 to bus 10. In all other aspects, the components of the power controller 7 in FIG. 2b operate identically as previously described with respect to FIG. 2a. Thus, in either of the embodiments of FIGS. 2a or 2b, the power output of fuel cell 5, transmitted through power output line 6, will be reduced until signals from signal lines 8 and 9 no longer dictate a need for a reduction in fuel cell output power.

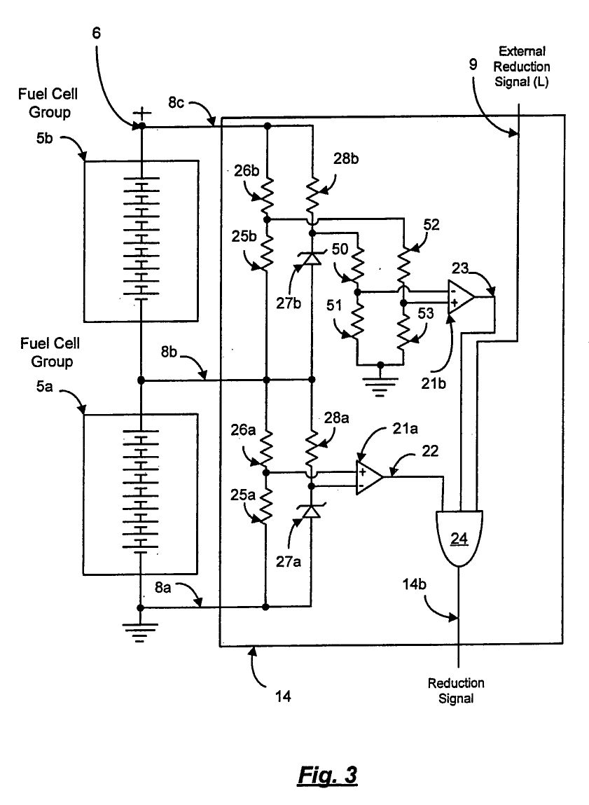

Referring to reduction logic circuit 14 in more detail, FIG. 3 shows an example circuit which may be used to prevent the overheating or damage of individual cells in fuel cell 5. Fuel cell stack 5 is represented as a 20-cell stack, with the cells divided into groups 5a and 5b of 10 cells each. The number of cells in a group can range between 2 and about 15, but are ideally within the range of 6-10 cells. The number of cell groups depends on the number of individual cells in the fuel cell, and the number of individual cells in each group. While two groups of cells 5a and 5b are illustrated, the circuitry and technique for protecting cells extends to stacks of any size, and with more than two groups of cells.

When reduction logic circuit 14 detects a condition where the fuel cell output must be decreased, output reduction signal 14b from AND gate 24 will be asserted at low voltage. For this to occur one of the inputs to AND gate 24 will have to be asserted low. External pressure signal 9 will therefore cause reduction logic output 14b to be asserted low when signal 9 is asserted low. The other inputs to AND gate 24 will also cause the same results when they are asserted low. These are shown as AND gate 24 inputs 22 and 23. The AND gate inputs 22 and 23 are fed by comparators 21a and 21b, which compare a divided voltage at the positive input to comparators 21a and 21b with a reference voltage across zener diodes 27a and 27b respectively. Voltage across fuel cell stack 5a is sensed via lines 8a and 8b and is divided using divider resistors 25a and 26a before being directed to comparator 21a. Likewise, voltage across fuel cell stack 5b is sensed via lines 8b and 8c and is divided using divider resistors 25b and 26b. Each respective voltage comparison for a fuel cell group 5a or 5b is accomplished by using the fuel cell group relative ground for the zener diode 27a or 27b and the divider resistors. Resistors 28a and 28b prevent excess current from flowing through zener diodes 27a and 27b respectively. For fuel cell group 5b, the voltage input to the comparator 21b can be further reduced using voltage divider resistors 50, 51, 52 and 53, which keeps the voltage within the range of standard comparators.

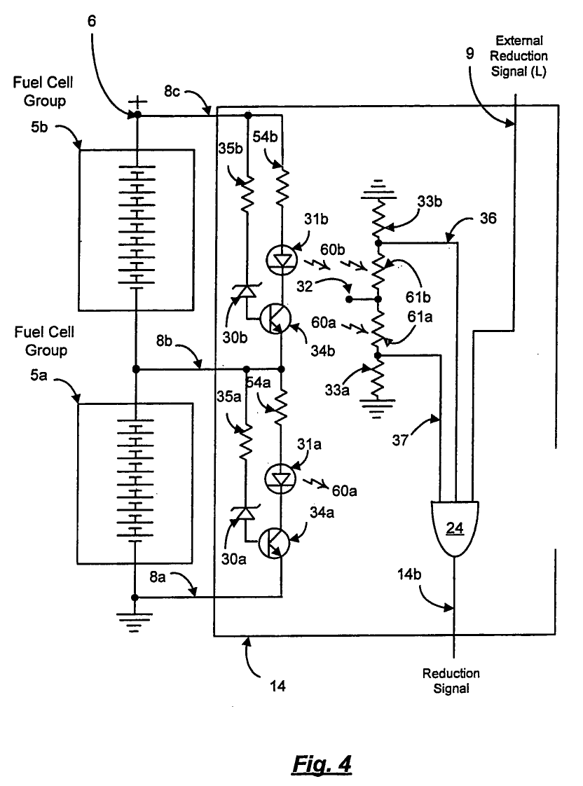

Another method that may be used is shown in FIG. 4. For fuel cell group 5a, a zener diode 30a is arranged to drive the base of transistor 34a, with current limiting resistor 35a. When the threshold voltage of zener diode 30a is exceeded, transistor 34a saturates and causes optocoupler LED 31a to turn on, with current limiting resistor 54a used to protect LED 31a. Light represented by arrows 60a is then transmitted to a photosensitive resistor 61a, which allows current to flow from voltage source 32, causing the input 37 to AND gate 24 to be asserted high. When light 60a is not sufficient, pulldown resistor 33a will cause the input 37 to AND gate 24 to be pulled to a low logic level. For fuel cell group 5b, the circuit is repeated except instead of using reference ground 8a as for fuel cell group 5a using the relative reference ground 8b. Also, like components are designated by the letter “b.”

External reduction signal 9, asserted low, can come from either a system controller or directly from the reformer 3. For example, if the hydrogen pressure to the fuel cell 5 drops too low when reformer 3 is used, the reduction signal 9 can be asserted low until the hydrogen pressure recovers to acceptable levels.

In all the above embodiments, a voltage reference, relative to the electrochemical cell group being regulated, is used to determine the logical output for that cell group. These may be logically combined to further determine whether the reduction signal 14b needs to be asserted. While two possible circuits have been illustrated in FIGS. 3 and 4, various other circuits may also be employed, and may be derived by those skilled in the art.

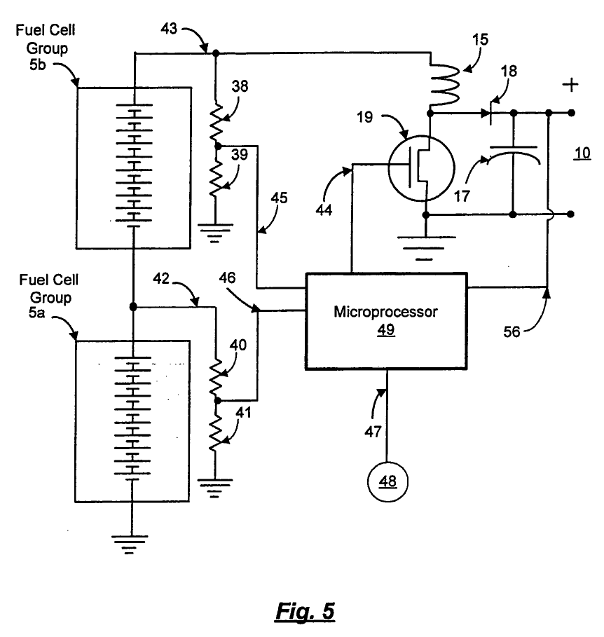

FIG. 5 shows an embodiment for the power controller utilizing a microcontroller or microprocessor to monitor the voltages of multiple groups of fuel cells, while also controlling a DC-DC converter and monitoring the hydrogen supply pressure. For fuel cell group 5a, the voltage of the group 5a represented by and sensed via line 42 is divided through dividing resistors 40 and 41. Reduced voltage in line 46 is sent to microcontroller 49, which includes an analog-to-digital input line configured to read the reduced voltage in line 46. Similarly, fuel cell group 5b has an output voltage represented by and sensed via line 43, which is then reduced by dividing resistors 38 and 39. Voltage in line 43 is therefore reduced sufficiently such that the resulting reduced voltage in line 45 may be read by microcontroller 49 via an analog-to-digital conversion.

Pressure transducer 48 is configured to read the hydrogen pressure from the hydrogen supply for fuel cell groups 5a and 5b. This is expressed as a voltage and transmitted via line 47 to microcontroller 49 and read via another analog-to-digital conversion.

Algorithms, resident within microcontroller 49, are configured to process the digitized voltages in lines 45 and 46 representing the fuel cell group voltages, as well as the digitized pressure reading in line 47 of the hydrogen supply to the fuel cell groups. Based on these algorithms, a pulse-width-modulated control signal 44 is sent to the gate driver of transistor 19 of a DC-DC converter. The DC-DC converter in FIG. 5 is similar to the DC-DC converter illustrated in FIGS. 2a and 2b and consists of transistor 19, inductor 15, diode 18, and smoothing capacitor 17. The output voltage at output bus 10 of the DC-DC converter may be directly read via an analog-to-digital input line 56 to microprocessor 49, or may be first reduced in voltage through a resistor divider circuit (not shown). An example of a microcontroller suitable for such an application is the 68HC908AB32 microcontroller (Freescale Semiconductor, Inc., Austin, Tex.), which includes input channels for analog-to-digital conversion, and PWM output channels.

The algorithms resident within microprocessor 49 may therefore be configured to read the voltage in lines 46 and 45 for fuel cell groups 5a and 5b, respectively, and adjust the fuel cell current by changing the pulse-width-modulated duty cycle of signal 44, such that a minimum voltage may be maintained within each fuel cell group 5a and/or 5b. Further, information from pressure transducer 48 may also be utilized by the algorithm resident within microprocessor 49 to adjust the pulse-width-modulated duty cycle of signal 44. This can be done when the hydrogen supply is limited, such as when the supply pressure drops below a pre-determined point. In such an event, the duty cycle may be changed for the DC-DC converter so that a lower amount of current is produced in the fuel cell, lowering the hydrogen consumption. This allows, for instance, the hydrogen pressure to rise when a hydrogen-producing reformer is coupled to the fuel cell, by lowering the hydrogen demand until-sufficient pressure may be developed and maintained by the reformer. This typically will occur when the reformer is ramping to a higher output level, and is unable to support the desired output of the fuel cell for a short period. In cases where sufficient hydrogen pressure may be maintained, and the voltages of fuel cell group 5a and 5b are above a desired minimum voltage, the DC-DC converter operation will be controlled by microprocessor 49 based on the voltage at output bus 10, as well as other information (when applicable), such as a battery charging current for batteries between output bus 10 and ground (not shown).

All resistors illustrated in FIGS. 3-5 may be preferably rated from 1,000 to 1,000,000 ohms. Selection of the appropriate resistor depends upon various factors, as is well known to those skilled in this art.

I claim:

1. A fuel cell power system, comprising:
(a) a fuel cell stack having at least two fuel cell groups in series with each other and with each fuel cell group comprised of more than one individual fuel cell, said fuel cell stack capable of generating electrical power for use by a load; and
(b) a power controller which receives the electrical power from said fuel cell stack and distributes said electrical power to an output bus, said power controller comprising:
(1) a DC-DC converter; and
(2) a reduction logic circuit operative to limit current through the DC-DC converter in response to voltage across each fuel cell group so that a minimum voltage is maintained across each fuel cell group.

2. The fuel cell power system of claim 1 wherein said reduction logic circuit compares the voltage across each fuel cell group with a reference voltage and generates a reduction signal to limit the current through the DC-DC converter when the voltage across any one of said fuel cell groups is less than said reference voltage.

3. The fuel cell power system of claim 2 wherein a zener diode provides said reference voltage.

4. The fuel cell power system of claim 2 wherein said reduction logic circuit includes a comparator to determine whether the reference voltage has been exceeded.

5. The fuel cell power system of claim 2 wherein said reduction logic circuit includes an optical coupling circuit to generate said reduction signal.

6. The fuel cell power system of claim 5 wherein said optical coupling circuit includes an optocoupler light emitting diode that turns on when the reference voltage has been exceeded, and a photosensitive device that controls an input logic level of a logic gate.

7. The fuel cell power system of claim 2 wherein said reduction logic circuit includes a microprocessor to determine whether the reference voltage has been exceeded, and to generate said reduction signal when the reference voltage has not been exceeded.

8. The fuel cell power system of claim 1 wherein said load is coupled to said output bus.

9. The fuel cell power system of claim 1 wherein a battery is coupled to said output bus.

10. A fuel cell power system, comprising:
(a) a reformer for generating hydrogen;
(b) a fuel cell stack having at least two fuel cell groups in series with each other and with each fuel cell group comprised of more than one individual fuel cell, said fuel cell stack capable of utilizing the hydrogen from said reformer for generating electrical power for use by a load; and
(c) a power controller which receives the electrical power from said fuel cell stack and distributes said electrical power to an output bus, said power controller comprising:
(1) a DC-DC converter; and
(2) a reduction logic circuit operative to limit current through the DC-DC converter in response to voltage across each fuel cell group so that a minimum voltage is maintained across each fuel cell group.

11. The fuel cell power system of claim 10 wherein said reduction logic circuit compares the voltage across each fuel cell group with a reference voltage and generates a reduction signal to limit the current through the DC-DC converter when the voltage across any one of said fuel cell groups is less than said reference voltage.

12. The fuel cell power system of claim 11 wherein a zener diode provides said reference voltage.

13. The fuel cell power system of claim 11 wherein said reduction logic circuit includes a comparator to determine whether the reference voltage has been exceeded.

14. The fuel cell power system of claim 11 wherein said reduction logic circuit includes an optical coupling circuit to generate said reduction signal.

15. The fuel cell power system of claim 14 wherein said optical coupling circuit includes an optocoupler light emitting diode that turns on when the reference voltage has been exceeded, and a photosensitive device that controls an input logic level of a logic gate.

16. The fuel cell power system of claim 11 wherein said reduction logic circuit includes a microprocessor to determine whether the reference voltage has been exceeded, and to generate said reduction signal when the reference voltage has not been exceeded.

17. The fuel cell power system of claim 10 wherein said load is coupled to said output bus.

18. The fuel cell power system of claim 10 wherein a battery is coupled to said output bus.

19. The fuel cell power system of claim 10 wherein the reduction logic circuit is also operative to limit current through the DC-DC converter in response to hydrogen pressure supplied by said reformer to said fuel cell stack so that a minimum pressure is maintained for the hydrogen supplied to the fuel cell stack.

20. The fuel cell power system of claim 19 wherein said minimum pressure is at least 0.1 psig.

21. A fuel cell power system, comprising:
(a) a fuel cell stack having at least two fuel cell groups in series with each other and with each fuel cell group comprised of more than one individual fuel cell, said fuel cell stack capable of generating electrical power for use by a load; and
(b) a power controller coupled to a microprocessor, the power controller receives the electrical power from said fuel cell stack and distributes said electrical power to an output bus, said power controller comprising a DC-DC converter controlled by said microprocessor such that the microprocessor reduces electrical current through the DC-DC converter in the event that voltage across any fuel cell group is less than a reference voltage, so that a minimum voltage is maintained across each fuel cell group.

22. The fuel cell power system of claim 21 wherein said fuel cell stack utilizes hydrogen supplied by a hydrogen reformer for generating said electrical power.

23. The fuel cell power system of claim 22 wherein the microprocessor reduces electrical current through the DC-DC converter in the event that hydrogen pressure supplied to the fuel cell stack is less than a desired pressure, so that a minimum hydrogen pressure to the fuel cell stack is maintained.
